(19) United States
(12) Patent Application Publication
(10) Pub. No.: US 2004/0141154 A1
(43) Pub. Date: Jul. 22, 2004

(54) Color projection display device

(76) Inventors: Ga-Lane Chen, Fremont, CA (US); Jyh Chain Lin, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/748,830

(22) Filed: Dec. 29, 2003

(30) Foreign Application Priority Data
Dec. 27, 2002 (TW) 91137600

(51) Int. Cl. G03B 21/00

(52) U.S. Cl. 353/31

(57) ABSTRACT

A color projection display device (3) includes a light source (30), a light modulation unit (32), a projection lens (34) and a screen (38). The light modulation unit includes a micro-mirror array (325) having a red micro-mirror, a green micro-mirror and a blue micro-mirror. Each micro-mirror functions as a color filter, and is capable of reflecting light beams emitted from the light source to the projection lens. A driver circuit offers a digital signal to the micro-mirror array to maintain each micro-mirror thereof is in an on state or in an off state. The projection lens projects the light beams reflected by the light modulation unit onto the screen.

### BACKGROUND OF THE INVENTION

1. Field of the Invention

The present invention relates to color projection display devices, and particularly to a color projection display device driven by a pulse width modulation driving device.

2. The Related Art

In many color projection display devices, a white light source is separated into red, blue and green sub-beams for separate modulation by corresponding color components of an incoming driving signal, and then the modulated sub-beams are recombined into a full color image for projection onto a viewing screen. Modulation of the sub-beams is commonly carried out using three separate electro-optical light modulators such as liquid crystal display (LCD) panels, one for each of the three sub-beams. U.S. Pat. No. 6,266,105 issued to Gleckman discloses a single panel scrolling raster projector, which eliminates the need to separate the white light into sub-beams prior to scrolling and produces a full color display image.

However, none of the above-described art provides a color projection display device with simple and convenient driving means.

### SUMMARY OF THE INVENTION

An object of the present invention is to provide a color projection display device with a driving means therefor.

In accordance with the invention, a color projection display device includes a light source, a light modulation unit, a projection lens and a screen. The light modulation unit includes a micro-mirror array having a red micro-mirror, a green micro-mirror and a blue micro-mirror. Each micro-mirror functions as a color filter, and is capable of reflecting light beams emitted from the light source to the projection lens. A driver circuit offers a digital signal to the micro-mirror array to maintain each micro-mirror thereof is in an on state or in an off state. The projection lens projects the light beams reflected by the light modulation unit onto the screen.

Other objects, advantages, and novel features of the present invention will become more apparent from the following detailed description when taken in conjunction with the accompanying drawings, in which:

### BRIEF DESCRIPTION OF THE DRAWINGS

FIG. 1 schematically shows a top elevation of a color projection display device according to the present invention;

FIG. 2 is a schematic, cross-sectional view of a light modulation device of the color projection display device of FIG. 1; and

FIG. 3 is a circuit diagram of a driving device used in the present invention.

### DETAILED DESCRIPTION OF THE INVENTION

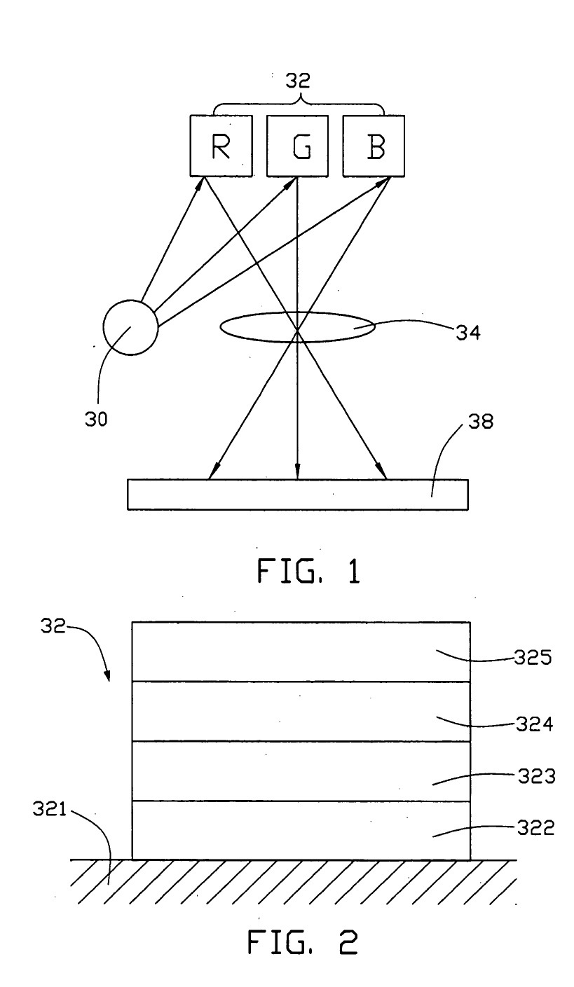

Referring to FIG. 1, a color projection display device 3 according to the present invention comprises a light source 30, a light modulation unit 32, a projection lens 34 and a screen 38.

The light source 30 is a white light source such as a metal halide lamp. The light modulation unit 32 corresponds to a pixel image of information displayed on the screen 38. Referring to FIG. 2, the light modulation unit 32 comprises a Complementary Metal-Oxide Semiconductor (CMOS) layer 322, a metal layer 323, a torsion layer 324 and a micro-lens array 325 formed on a silicon substrate 321 in that sequence. The micro-lens array 325 is made by a micro-electromechanical system (MEMS), and comprises a red micro-mirror (not labeled), a green micro-mirror (not labeled) and a blue micro-mirror (not labeled). Aluminum is evaporated on an outer surface of the micro-mirrors in order that the micro-mirrors operate as square mirrors (for example) having high reflectivity. An address electrode layer (not shown) is formed on the torsion layer 324, for providing a driving signal to the micro-lens array 325. Each micro-mirror of the micro-lens array 325 can perform switching between an on state and an off state according to a driving signal. In the on state, the micro-mirror reflects light beams emitted from the light source 30 to the projection lens 34. In the off-state, the micro-mirror does not reflect any light beams. For example, when the red micro-mirror is in the on state according to a driving signal, it reflects incident light beams such that red light beams are obtained. On the other hand, in the off state, the red micro-mirror does not reflect any incident light beams, which produces no color (i.e., black).

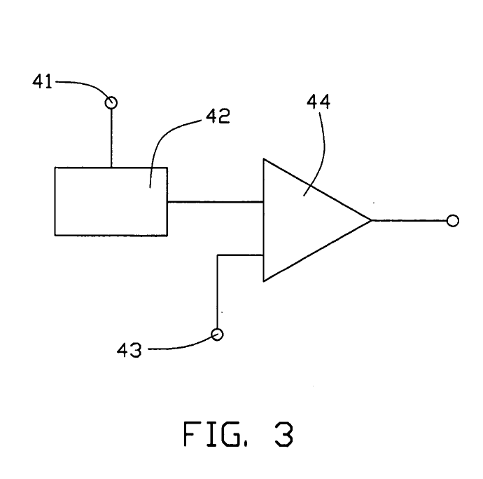

The driving signal is generated by a pulse width modulation (PWM) driving device 4 as show in FIG. 3. The PWM driving device 4 includes a sawtooth wave generator 42 and a comparator 44. The sawtooth wave generator 42 receives a display signal from an outer controller 41, and outputs a sawtooth wave signal. The output of the sawtooth wave generator 42 is connected to a positive input terminal (not labeled) of the comparator 44. A modulation signal source 43 is connected to a negative input terminal (not labeled) of the comparator 44.

In use, the modulation signal source 43 outputs a modulation signal, and the modulation signal is compared with the sawtooth wave signal in the comparator 44. The comparator 44 outputs a driving signal to drive the micro-mirrors. The comparator 44 outputs an on-state driving signal to each micro-mirror when the modulation signal is lower than the sawtooth wave signal, and outputs an off-state driving signal to the micro-mirror when the modulation signal is equal to or higher than the sawtooth wave signal. In other words, the driving signal consists of two digital states: one digital state can maintain one micro-mirror of the micro-lens array in the on state, and the other digital state can maintain the micro-mirror in the off state. Accordingly, the red micro-mirror can offer two color states, red or black; the green micro-mirror can offer two color states, green or black and the blue micro-mirror can offer two color states, blue or black. As a result, the micro-mirror array 325 can offer eight (2³) color states: black, black, black; black, black, red; black, red, green; black, green, black; red, green, blue; red, blue, black; green, blue, black; and blue, black, black. Thus, the light modulation unit 32 performs switching between the on state and the off state according to a driving signal. In particular, the light modulation unit 32 reflects light beams emitted from the light source 30 to the projection lens 34 in the on state, and does not reflect the light beams to the projection lens 34 in the off state. The projection lens 34 enlarges and displays the light beams reflected by the micro-mirrors on a screen, for generating full color images thereon.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A color projection display device, comprising:
a light source;
a micro-mirror unit; and
a projection lens;
wherein the micro-mirror unit performs switching between an on state and an off state according to a driving signal, the micro-mirror unit reflecting light beams emitted from the light source to the projection lens in the on state, and not reflecting said light beams to the projection lens in the off state, the projection lens enlarging and displaying the light beams reflected by the micro-mirror on a screen for generating images thereon.

2. The color projection display device as described in claim 1, wherein the micro-mirror unit is made by a micro-electromechanical system.

3. The color projection display device as described in claim 1, wherein the driving signal is generated by a pulse width modulation driving device.

4. The color projection display device as described in claim 1, wherein the micro-mirror unit comprises a complementary metal-oxide semiconductor layer, a metal layer, a torsion layer and a micro-lens array formed on a silicon substrate.

5. The color projection display device as described in claim 4, wherein the micro-mirror unit further comprises an address electrode formed on the torsion layer for providing the driving signal to the micro-lens array.

6. The color projection display device as described in claim 4, wherein the micro-lens array comprises a red micro-mirror, a green micro-mirror and a blue micro-mirror.

7. The color projection display device as described in claim 6, wherein the driving signal comprises two digital states; one digital state maintaining one micro-mirror of the micro-lens array in the on state, and the other digital state maintaining the micro-mirror in the off state.

8. A color projection display device, comprising: a light source, a light modulation unit for modulating colors of light beams emitted from the light source, and a projection lens for projecting the light beams reflected by the light modulation unit onto a screen; the light modulation unit comprising:
a micro-mirror array including a red micro-mirror, a green micro-mirror and a blue micro-mirror, each micro-mirror functioning as a color filter and capable of reflecting the light beams emitted from the light source to the projection lens; and
a driver circuit for providing a digital signal to the micro-mirror array to maintain each micro-mirror thereof in an on state or in an off state.

9. The color projection display device as described in claim 8, wherein the micro-mirror array is made by a micro-electromechanical system.

10. The color projection display device as described in claim 1, wherein the driver circuit is controlled using a pulse width modulator (PWM).

11. A color projection display device, comprising: a light source, a light modulation unit for modulating colors of light beams emitted from the light source, and a projection lens for projecting the light beams reflected by the light modulation unit onto a screen; the light modulation unit comprising:
a micro-mirror array including at least three micro-mirrors each characterized with one single original color, and functioning as a color filter and being capable of reflecting the light beams emitted from the light source to the projection lens; and
a driver circuit for providing a digital signal to the micro-mirror array to maintain each micro-mirror thereof in an on state or in an off state; wherein through an on-off state change of each of said micro-mirror, a combination of the light beams defines at least 2³ alternatives.
